(19) United States
(12) Patent Application Publication
(10) Pub. No.: US 2007/0157272 A1
(43) Pub. Date: Jul. 5, 2007

(54) Content retransmission system and method using infrared communication

(75) Inventors: Jong Hee Kim, Seongnam-si (KR); Hee Won Jung, Suwon-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/545,885

(22) Filed: Oct. 11, 2006

(30) Foreign Application Priority Data
Jan. 2, 2006 (KR) 2006-0000197

(51) Int. Cl. H04N 7/173; H04N 7/18

(52) U.S. Cl. 725/100; 725/74; 725/78; 725/131

(57) ABSTRACT

A content retransmission system comprises a content providing server for providing, through external networks, information content purchased and an associated purchase breakdown, a smart communicator for remotely controlling the purchase process, and for wirelessly transmitting, short-range, a transfer request for the information content and a current location reference, a home server for receiving the information content and associated purchase breakdown and storing it and the associated purchase breakdown, and for receiving the transfer request and current location reference and transmitting information content corresponding to the transfer request through a power line, and a communication apparatus for receiving the information content through the power line and transmitting, by infrared, the received information content to the smart communicator.

### CLAIM OF PRIORITY

This application claims priority to an application entitled “CONTENT RETRANSMISSION SYSTEM AND METHOD USING INFRARED COMMUNICATION,” filed in the Korean Intellectual Property Office on Jan. 2, 2006 and assigned Serial No. 2006-0000197, the contents of which are incorporated herein by reference.

### BACKGROUND OF THE INVENTION

1. Field of the Invention

The present invention relates generally to a content retransmission system and method and, more particularly, to a content retransmission system and method using infrared communication, wherein information content purchased through an external communication network can be transmitted to a smart communicator using illuminating visible-light communication over power lines.

2. Description of the Related Art

In recent years, radio communication systems have come into widespread use with the popularization of portable terminals. Owing to a shortage of available frequency resources, infrared communication systems using infrared rays, which have wavelengths shorter than those of radio waves, have been actively developed. However, in addition to the shortage of frequency resources, it has been confirmed that radio waves have detrimental influence on various medical or precision instruments. In safety aspects of communication, visible-light communication systems attract much attention.

Development of blue light-emitting diodes (LEDs) has enabled realization of white LEDs. Compared with an incandescent lamp or fluorescent lamp, a white LED consumes much less power, is smaller, and has a longer lifetime. Research efforts are ongoing to transmit signals using white LEDs by controlling on/off operations or the amount of light emitted from the white LEDs.

Active research is taking place to integrate a signal transmission function of white LEDs with a power line communication (PLC) system. Such an integrated communication system utilizing visible light is not detrimental to the human body, enables safe communication, and is expected to provide worthwhile applications.

FIG. 1 is a block diagram showing a conventional broadcast content retransmission system.

As shown in FIG. 1, the broadcast content retransmission system comprises an information source 10, a power line modem 12, outlets 14 and 16 interconnected by a power line, an LED lighting fixture 20, and a light-receiving terminal 30.

The information source 10 is an information output apparatus providing various kinds of information, and may be a computer or a device composed of a tuner and receiver for television, cable television or radio broadcasting. Hence, broadcast information may be, for example, video, audio, voice, still image, and/or character data.

The power line modem 12 modulates information from the information source 10 and superimposes the modulated information on a power wave carried on the power line interconnecting the outlets 14, 16 to transmit the modulated information through the power line. Although an ordinary PLC system includes a demodulating means to support two-way communication, the broadcast signal retransmission system is one-way and does not have to include a demodulating means. Frequency division multiplexing may be used for multiplexing information. The power line may be an indoor or outdoor electric power transmission line.

The LED lighting fixture 20 is connected to the power line, and illuminates the vicinity thereof. The LED lighting fixture 20 includes an AC/DC converter 22, a band pass filter (BPF) 24, a coupler 26, and a plurality of LEDs 28. Because DC power is needed to drive the LEDs 28 to emit light, the AC/DC converter 22 converts AC power from the power line into DC power. The AC/DC converter 22 adjusts the voltage level of the DC power according to an operating voltage of the LEDs 28, and supplies operating power to the BPF 24.

The BPF 24 acts to extract an information signal superimposed on the power line, and may selectively extract a single information signal from multiple information signals.

The coupler 26 couples the information signal extracted by the BPF 24 to the wave of the DC power converted by the AC/DC converter 22. Hence, the level of the voltage fed to the LEDs 28 can be changed according to the information signal, thereby making it possible to control the amount of light of the LEDs and an on/off operation thereof. For example, the power from the AC/DC converter 22 can be controlled by the information signal from the BPF 24 to turn on and off the LEDs 28.

The LEDs 28 are primarily light sources for illumination, and may be white LEDs. The LEDs 28 are driven by the power from the coupler 26 to emit light. Because an LED 28 has a fast response time, the amount of light of the LED or the on/off operation thereof can be controlled by an information signal, enabling transmission of the information signal in the form of visible light.

The light-receiving terminal 30 includes a light-receiving means to receive light emitted from the LED lighting fixture 20, and extracts an information signal from the received light and demodulates the extracted information signal to produce desired information. The light-receiving terminal 30 may be any appliance having a light-receiving means, such as a personal computer, portable terminal, mobile phone, audio instrument or television set.

However, in the conventional broadcast content retransmission system, broadcasting content is not selectively provided to a user at a particular location according to user requests, therefore the user cannot be provided with only that content requested in real time.

### SUMMARY OF THE INVENTION

The present invention has been made in view of the above problems, and one aspect of the present invention is to provide a content retransmission system and method using infrared communication, wherein information content purchased through an external communication network can be retransmitted in real time to a desired destination according to user requests.

Another aspect of the present invention is to provide a content retransmission system and method using infrared communication, wherein purchased information content can be retransmitted to a desired destination through a rapid transmission means according to user requests.

In accordance with an embodiment of the invention, there is provided a content retransmission system using infrared communication, the system including a content providing server for providing information content purchased through external networks and a purchase breakdown associated with the purchased information content. The system further includes a home network having a smart communicator for remotely controlling a purchase process for the information content, and for transmitting a transfer request for the information content and a current location reference through short-range wireless communication. The home network also includes a home server for receiving the information content and associated purchase breakdown from the content providing server and storing the received information content and associated purchase breakdown, and for receiving the transfer request and current location reference from the smart communicator and transmitting information content corresponding to the transfer request through a power line. Also included in the home network is a communication apparatus for receiving the information content from the home server through the power line and transmitting the received information content to the smart communicator in the form of an infrared signal.

The home server may include an Internet communication module for connecting to the content providing server through an Internet network to receive the information content and associated purchase breakdown. As other components, the home server may have a memory section for storing the information content and associated purchase breakdown, a power line modem for superimposing the information content on a power wave carried on the power line to transmit the information content through the power line, and a controller for controlling, in response to the transfer request from the smart communicator, the power line modem to transmit the information content to the communication apparatus near to the smart communicator.

The smart communicator may feature a short-range communication module for transmitting the transfer request for the information content and the current location reference to the home server, an infrared communication module for receiving the information content, transmitted from the home server in response to the transfer request, in the form of an infrared signal from the communication apparatus, a decoder for decoding the received infrared signal into an information content, and a user interface for outputting the decoded information content.

The user interface may include a display section for displaying a video part of the decoded information content, and an audio processor for outputting an audio part of the decoded information content.

Preferably, the smart communicator further comprises a memory section for storing the decoded information content.

Preferably, the smart communicator further comprises a key input section for inputting the transfer request for the purchased information content and current location reference.

In accordance with another embodiment of the invention, there is provided a content retransmission method using infrared communication. The method includes purchasing information content from a content providing server through external networks. The purchased information content and an associated purchase breakdown from the content providing server are received. The received information content and associated purchase breakdown are stored or saved. A transfer request for the purchased information content and a current location reference are received from a smart communicator. According to the transfer request and current location reference received from the smart communicator, the purchased information content is transmitted through a power line. A communication apparatus receives the information content transmitted through the power line and transmits the received information content to the smart communicator in the form of an infrared signal.

Preferably, the content retransmission method further comprises the acts, performed by the smart communicator, of: receiving the infrared signal from the communication apparatus; decoding the received infrared signal into an information content; and outputting the decoded information content through a user interface.

The step of outputting the decoded information content may include: displaying a video part of the decoded information content through a display section of the user interface; and outputting an audio part of the decoded information content through an audio processor of the user interface.

Preferably, the content retransmission method further comprises the step of storing the decoded information content.

In a feature of the present invention, particular information content is purchased through an external network, and provided to and stored in a home server. When a location reference of a smart communicator and a transfer request for the stored information content are received from the smart communicator, the requested information content is superimposed on a power wave carried on a power line and transmitted to a communication apparatus corresponding to the location reference. The communication apparatus transmits the information content received through the power line to the smart communicator in the form of an infrared signal. As a result, purchased information content can be rapidly retransmitted in response to content retransmission requests.

### BRIEF DESCRIPTION OF THE DRAWINGS

FIG. 1 is a block diagram showing a conventional broadcast content retransmission system.

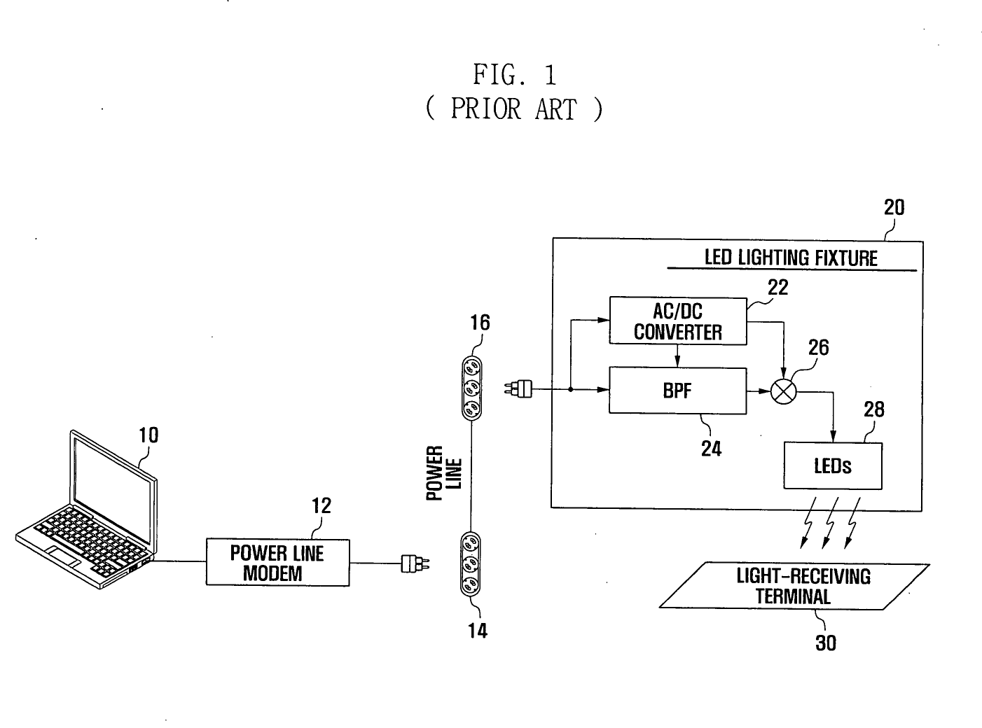

FIG. 2 is a block diagram showing a content retransmission system using infrared communication according to an exemplary embodiment of the present invention.

FIG. 3 is a block diagram showing one example of the configuration of a home server of FIG. 2.

FIG. 4 is a block diagram showing, by way of example, the configuration of a smart communicator of FIG. 2.

FIG. 5 is a flow diagram showing one variation of a content retransmission method using infrared communication according to another embodiment of the present invention.

### DETAILED DESCRIPTION THE INVENTION

Hereinafter, example embodiments of the present invention are described in detail with reference to the accompanying drawings. The same reference symbols are given to the same or corresponding elements in the drawings. For clarity of presentation, some constructions or processes known in the art are not described or drawn.

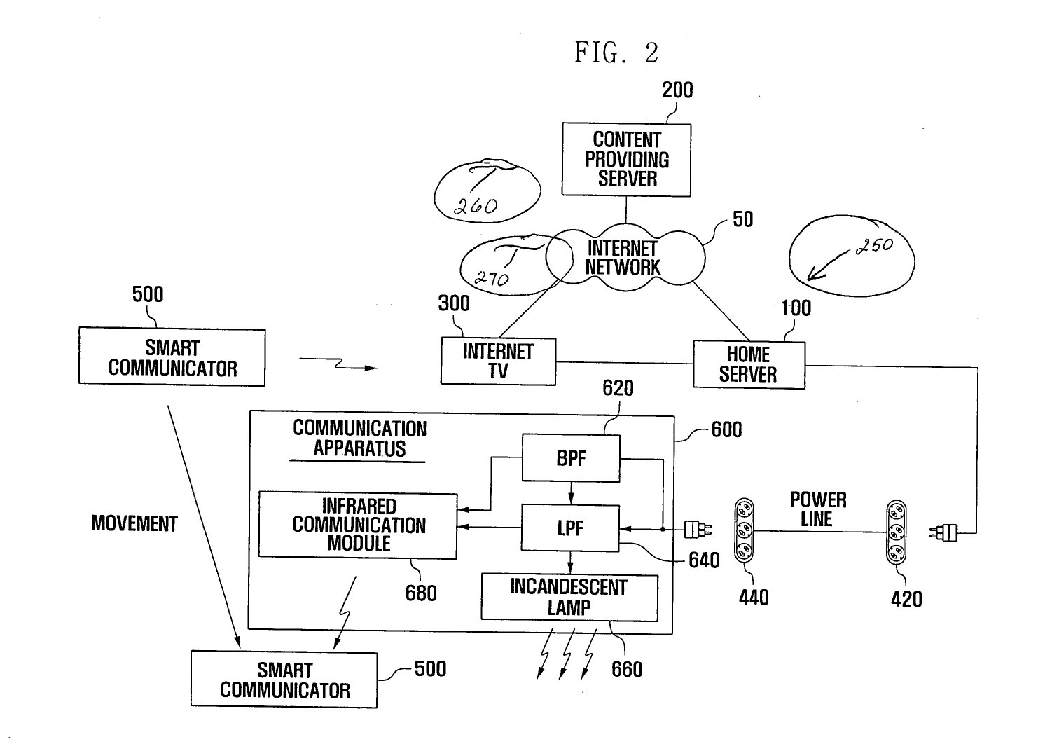

FIG. 2 is a block diagram showing, by way of illustrative and non-limitative example, a content retransmission system using infrared communication according to an embodiment of the present invention. The content retransmission system includes a content providing server 200 connected to a home network 250 by means of a network 50 such as the Internet. The home network 250 is a particular client of the content providing server 200, and communicates with the server 200 by means of a content providing network (not shown), part of which may reside on the Internet network 50.

As shown in FIG. 2, by remote control operations of a smart communicator 500, the user connects through an Internet television (TV) 300 to the content providing server 200 on the Internet network 50. Through a network external to the content providing network, the user then purchases desired information content. Two paths 260, 270 on respective external networks are shown in FIG. 2.

The content providing server 200 connecting to a home server 100 through the Internet network 50 provides a purchase breakdown regarding the information content purchased by the user. The home server 100 stores the purchase breakdown provided from the content providing server 200.

After payment for the purchased information content, the content providing server 200 connects to the home server 100 through the Internet network 50 to provide the information content purchased by the user. The home server 100 stores the information content provided from the content providing server 200.

When a retransmission request for the information content is received from the smart communicator 500, which is located in a site where infrared rays can be received from a communication apparatus 600 through short-range wireless communication, the home server 100 transmits the stored information content received from the content providing server 200 to the communication apparatus through a power line.

The communication apparatus 600 receives a power signal, and outputs the received power signal in the form of infrared or incandescent light.

The communication apparatus 600 includes a BPF 620, a low pass filter (LPF) 640, an incandescent lamp 660, and an infrared communication module 680.

The BPF 620 extracts a content signal superimposed on the power line. The BPF 620 may selectively extract a desired one of multiple content signals. The LPF 640 extracts information passable through low frequency bands from the multiple content signals.

The incandescent lamp 660 outputs the information received from the LPF 640 in the form of incandescent light. The infrared communication module 680 receives the content signal from the BPF 620, converts the received content signal into an infrared signal, and outputs the infrared signal to the smart communicator 500.

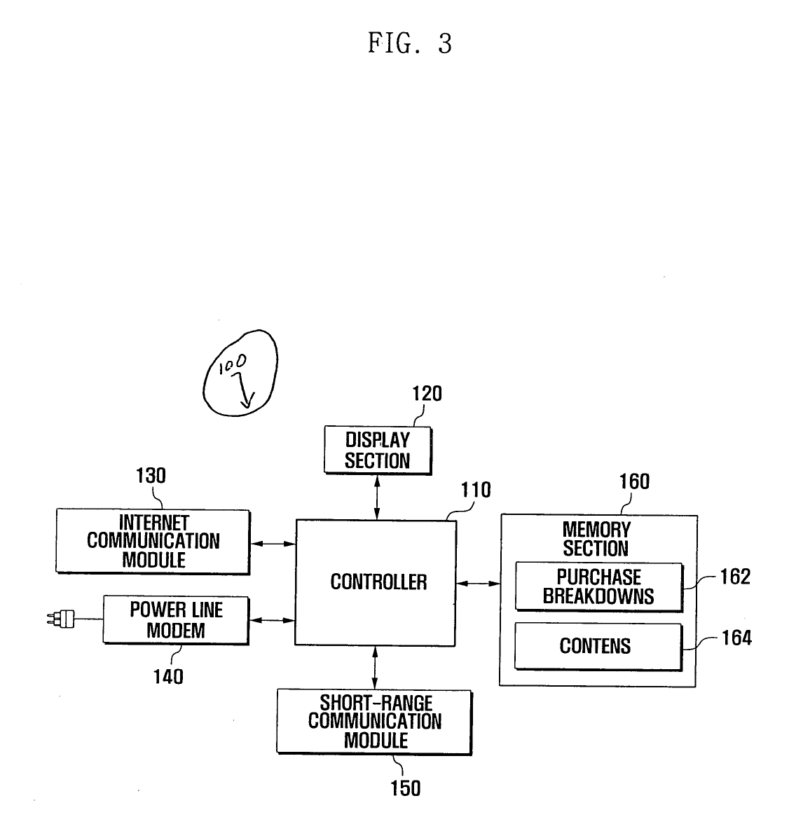

FIG. 3 is a block diagram showing an exemplary configuration of the home server 100 of FIG. 2.

As shown in FIG. 3, the home server 100 includes a controller 110, a display section 120, an Internet communication module 130, a power line modem 140, a short-range communication module 150, and a memory section 160.

The controller 110 controls the overall operation of the home server 100, and controls operations of electronic appliances on a home network connected with the home server 100 for communication. In the present embodiment, in response to a transfer request for information content from the smart communicator 500, the controller 110 controls the home server 100 to transmit the information content, provided from the information content providing server 200, through the power line to the communication apparatus 600 near to the smart communicator 500.

The display section 120 displays status information regarding the operation of the home server 100. In the present embodiment, the display section 120 also displays a video part of the information content provided from the content providing server 200.

The Internet communication module 130 provides functions for interconnecting the home server 100 and the content providing server 200 through the Internet network 50.

The power line modem 140 superimposes the information content on a power wave carried on the power line to transmit the information content through the power line.

The short-range communication module 150 provides functions for interconnecting the home server 100 and the smart communicator 500 through short-range wireless communication in the home.

The memory section 160 stores programs and associated data needed to operate the home server 100. In the present embodiment, the memory section 160 stores information content 164 and an associated purchase breakdown 162 provided from the content providing server 200.

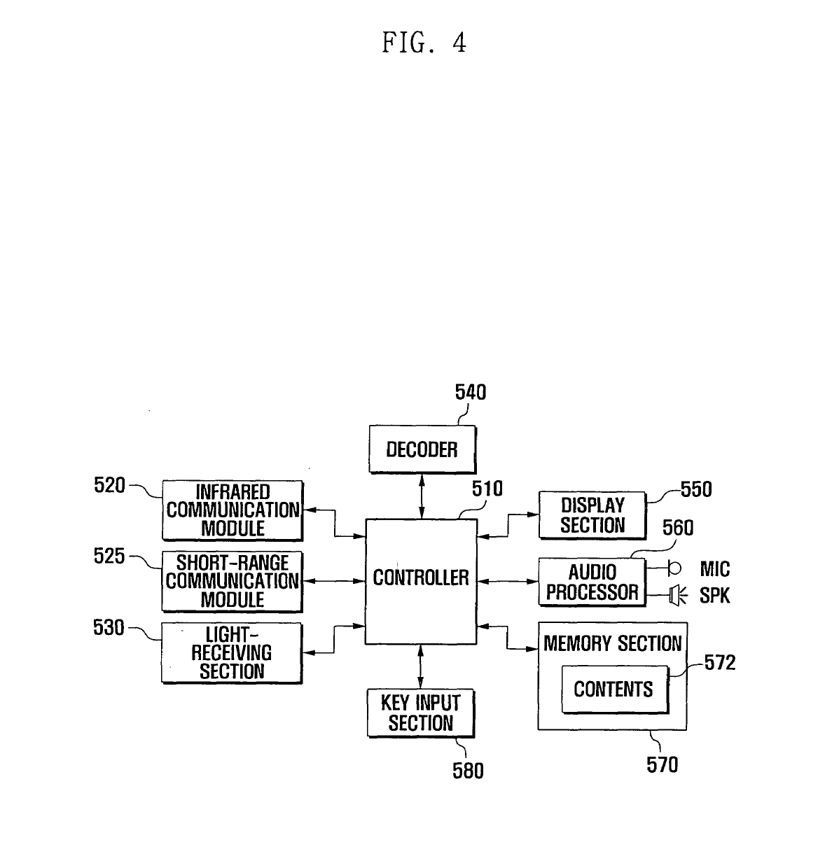

FIG. 4 is a block diagram showing one example configuration of the smart communicator 500 of FIG. 2.

As shown in FIG. 4, the smart communicator 500 includes a controller 510, an infrared communication module 520, a short-range communication module 525, a light-receiving section 530, a decoder 540, a display section 550, an audio processor 560, a memory section 570, and a key input section 580.

The controller 510 controls the overall operation of the smart communicator 500. In the present embodiment, the controller 510 controls the smart communicator 500 to transmit a transfer request for a purchased information content and a location reference of the smart communicator 500 to the home server 100 through short-range wireless communication. The controller 510 also controls the smart communicator 500 to extract an information signal from an infrared or light signal outputted from the communication apparatus 600, where the infrared or light signal is generated from information content transmitted from the home server 100 through the power line to the communication apparatus 600.

The infrared communication module 520 corresponds, for communication, to the infrared communication module 680 of the communication apparatus 600. In the present embodiment, the infrared communication module 520 receives an infrared signal from the communication apparatus 600.

The short-range communication module 525 provides short-range wireless communication capabilities including infrared communication to control an operation of the home server 100 in the home. In the present embodiment, the short-range communication module 525 transmits a transfer request for purchased information content to the home server 100.

The light-receiving section 530 receives a light signal from the incandescent lamp 660 of the communication apparatus 600.

The decoder 540 decodes an infrared signal received by the infrared communication module 520 or a light signal received by the light-receiving section 530. In the present embodiment, the decoder 540 decodes an infrared signal received by the infrared communication module 520 into content data.

The display section 550 displays overall status information on operations of the smart communicator 500. In the present embodiment, the display section 550 displays a video part of the content data decoded by the decoder 540.

As a voice communication capability of the smart communicator 500 according to control of the controller 510, the audio processor 560 converts an analog audio signal from a microphone MIC into a digital signal. The smart communicator, as a further capability under control of the controller 510, converts a digital audio signal from the controller 510 into an analog signal and outputs the converted analog signal through a speaker SPK. In the present embodiment, the audio processor 560 outputs an audio part of the decoded content data.

The memory section 570 stores programs needed to operate the smart communicator 500, and may also store operation setting information of the home server 100. In the present embodiment, the memory section 570 also stores information content 572 provided from the home server 100.

The key input section 580 includes keys for inputting commands to control operations of the smart communicator 500 through the controller 510 and to remotely control operations of the home server 100 in the home.

In the present embodiment, the key input section 580 includes keys for inputting the location reference of the smart communicator 500 and a transfer request for desired information content, both of which are to be transmitted to the home server 100.

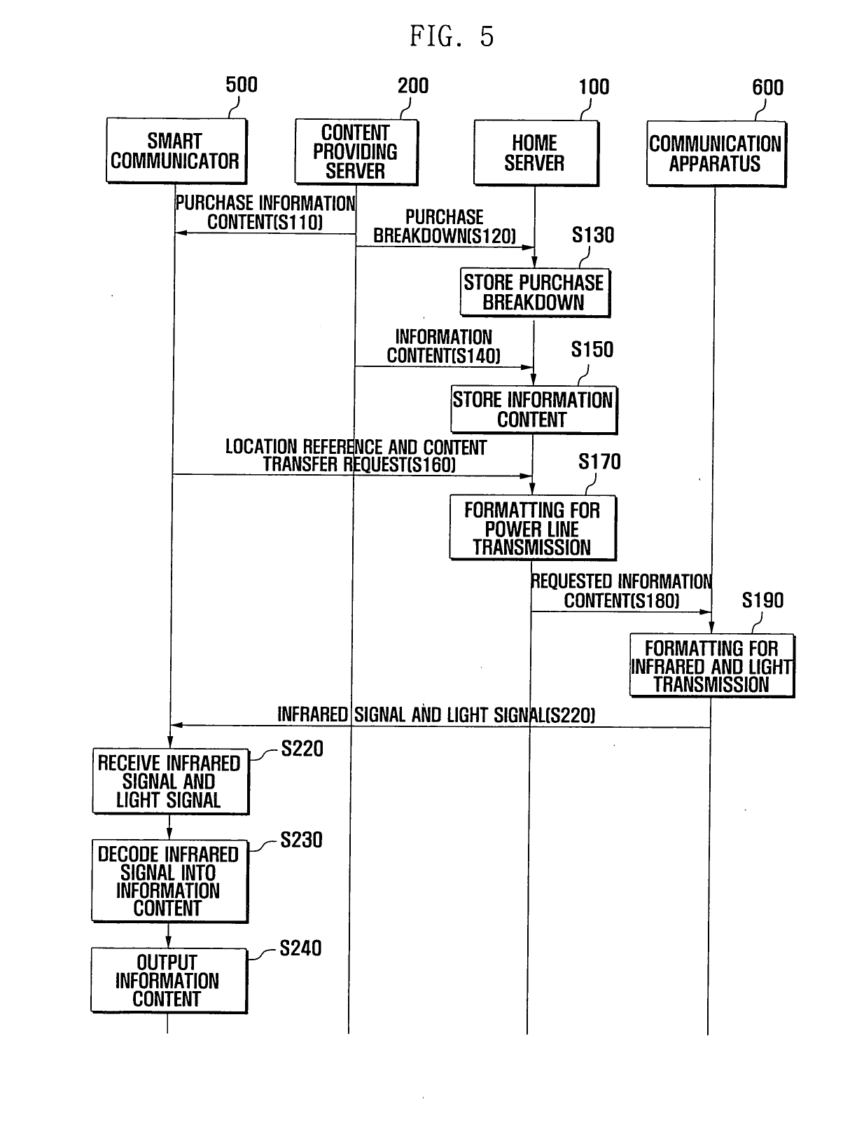

FIG. 5 is a flow diagram showing a particular implementation of a content retransmission method using infrared communication according to another embodiment of the present invention.

Firstly, after particular information content is purchased and paid for in full according to control of the smart communicator 500 (S110), the content providing server 200 transmits a purchase breakdown regarding the purchased information content to the home server 100 (S120). The home server 100 stores the purchase breakdown transmitted from the content providing server 200 (S130).

The content providing server 200 transmits the purchased information content to the home server 100 (S140). The home server 100 stores the information content transmitted from the content providing server 200 (S150).

When a location reference of the smart communicator 500 and a transfer request for a desired information content from the smart communicator 500 are received (S160), the home server 100 converts the format of the requested information content into a format transferable through the power line (S170), and transmits the format-converted information content over the power line to the communication apparatus 600 (S180).

The communication apparatus 600 converts the format of the information content transmitted from the home server 100 into a format transferable as an infrared signal and a light signal. In the present embodiment, the communication apparatus 600 generates an infrared signal and a light signal corresponding to the received information content (S190), and outputs the infrared signal and light signal (S210).

The smart communicator 500 receives the infrared signal and the light signal from the communication apparatus 600 (S220), decodes the received infrared signal into a corresponding information content (S230), and outputs and/or stores the decoded information content (S240).

As apparent from the above description, the present invention aims to provide a content retransmission system and method wherein a particular information content is purchased through an external network, and provided to and stored in a home server; and when a location reference of a smart communicator and a transfer request for the stored information content are received from the smart communicator, the requested information content is superimposed on a power wave carried on the power line and transmitted to a communication apparatus corresponding to the location reference, and the communication apparatus transmits the information content received through the power line to the smart communicator in the form of an infrared signal. Hence, purchased information contents can be rapidly retransmitted in response to content retransmission requests.

The present invention is disclosed in the preferred embodiments shown in this specification and in the accompanying drawings. This disclosure is not intended to limit the scope of the invention, but to serve only for illustrative purposes. It should be understood to the ordinary person skilled in the art that various changes or modifications of the embodiments are possible without departing from the spirit of the invention.

What is claimed is:

1. A content retransmission system using infrared communication, comprising:
a home network; and
a content providing server for providing information content purchased through a network external to the home network, and for providing a purchase breakdown associated with the purchased information content,
wherein said home network includes:
a smart communicator for remotely controlling a purchase process for the information content, and for transmitting a transfer request for the information content and a current location reference through short-range wireless communication;
a home server for receiving the information content and associated purchase breakdown from the content providing server and storing the received information content and associated purchase breakdown, and for receiving the transfer request and current location reference from the smart communicator and transmitting information content corresponding to the transfer request through a power line; and
at least one communication apparatus for receiving the information content from the home server through the power line and transmitting the received information content to the smart communicator in the form of an infrared signal.

2. The content retransmission system of claim 1, wherein the home server comprises:
an Internet communication module for connecting to the content providing server through an Internet network to receive the information content and the associated purchase breakdown;
a memory section for storing said information content and the associated purchase breakdown;
a power line modem for superimposing the information content on a power wave carried on the power line to transmit the information content through the power line; and
a controller for controlling, in response to the transfer request from the smart communicator, the power line modem to transmit the information content to a particular communication apparatus of said at least one communication apparatus nearest to the smart communicator.

3. The content retransmission system of claim 2, wherein the smart communicator comprises:
a short-range communication module for transmitting the transfer request for the information content and the current location reference to the home server;
an infrared communication module for receiving the information content, transmitted from the home server in response to the transfer request, in the form of an infrared signal from the particular communication apparatus;
a decoder for decoding the received infrared signal into an information content; and
a user interface for outputting the decoded information content.

4. The content retransmission system of claim 3, wherein the user interface includes:
a display section for displaying a video part of the decoded information content; and
an audio processor for outputting an audio part of the decoded information content.

5. The content retransmission system of claim 3, wherein the smart communicator further comprises a memory section for storing the decoded information content.

6. The content retransmission system of claim 3, wherein the smart communicator further comprises a key input section for inputting the transfer request for the purchased information content and current location reference.

7. The content retransmission system of claim 1, wherein the smart communicator comprises:
a short-range communication module for transmitting the transfer request for the information content and the current location reference to the home server;
an infrared communication module for receiving the information content, transmitted from the home server in response to the transfer request, in the form of an infrared signal from a nearest particular one of said at least one communication apparatus;
a decoder for decoding the received infrared signal into an information content; and
a user interface for outputting the decoded information content.

8. A content retransmission system using infrared communication, comprising:
a home network; and
a content providing server for providing information content purchased, and for providing a purchase breakdown associated with the purchased information content,
wherein said home network includes:
a smart communicator for remotely controlling a purchase process for the information content, and for transmitting a transfer request for the information content and a current location reference through short-range wireless communication;
a home server configured for receiving the information content and associated purchase breakdown from the content providing server and saving the received information content and associated purchase breakdown, and for, upon receiving the transfer request and current location reference from the smart communicator, transmitting, in real time, information content corresponding to the transfer request through a power line; and
a communication apparatus for receiving, in real time, the information content from the home server through the power line and transmitting, in real time, the received information content to the smart communicator in the form of an infrared signal.

9. The content retransmission system of claim 8, comprising a plurality of communication apparatuses of which said communication apparatus is one, said system being configured for selectively transmitting said information content from the home server to a particular one of said communication apparatuses that is nearest to said smart communicator.

10. The content retransmission system of claim 9, wherein the purchasing of said information content is through a network external to that over which said content providing server communicates with said home network.

11. The content retransmission system of claim 8, comprising a plurality of communication apparatuses of which said communication apparatus is one, said system being configured for selectively transmitting said information content from the home server to a particular one of said communication apparatuses based on a source location of said transfer request.

12. The content retransmission system of claim 11, wherein said particular one is a communication apparatus of said plurality that sent said transfer request.

13. The content retransmission system of claim 12, wherein the purchasing of said information content is through a network external to that over which said content providing server communicates with said home network.

14. The content retransmission system of claim 11, wherein the purchasing of said information content is through a network external to that over which said content providing server communicates with said home network.

15. The content retransmission system of claim 8, wherein the purchasing of said information content is through a network external to that over which said content providing server communicates with said home network, said smart communicator being a mobile device.

16. The content retransmission system of claim 8, wherein said communication apparatus comprises, for communication with said smart communicator, an incandescent lamp and infrared communication module

17. A content retransmission method using infrared communication, comprising:
purchasing information content from a content providing server through a network external to that by means of which said server communicates with a client;
receiving, by said client from the content providing server, the purchased information content and an associated purchase breakdown and storing the received information content and associated purchase breakdown;
receiving, from a smart communicator, a transfer request for the purchased information content and a current location reference;
transmitting, according to the transfer request and current location reference received from the smart communicator, the purchased information content through a power line; and
receiving, by a communication apparatus, the information content transmitted through the power line and transmitting the received information content to the smart communicator on an infrared signal.

18. The content retransmission method of claim 17, further comprising the acts, performed by the smart communicator, of:
receiving the infrared signal from the communication apparatus;
decoding the received infrared signal into information content; and
outputting the decoded information content through a user interface.

19. The content retransmission method of claim 18, wherein the step of outputting the decoded information content includes:
displaying a video part of the decoded information content through a display section of the user interface; and
outputting an audio part of the decoded information content through an audio processor of the user interface.

20. The content retransmission method of claim 18, further comprising the act of storing the decoded information content.
